(19) United States
(12) Patent Application Publication
(10) Pub. No.: US 2019/0152832 A1
(43) Pub. Date: May 23, 2019

(54) Microwave Tempering of Glass Substrates

(71) Applicant: PPG INDUSTRIES OHIO, INC., Cleveland, OH (US)

(72) Inventors: Wei XU, Cheswick, PA (US); Yu JIAO, Blawnox, PA (US); David A. ALLERTON, Pittsburgh, PA (US); Dennis J. O'SHAUGHNESSY, Allison Park, PA (US); Chao YU, Horseheads, NY (US)

(73) Assignee: PPG Industries Ohio, Inc., Cleveland, OH (US)

(21) Appl. No.: 16/091,251

(22) PCT Filed: Apr. 3, 2017
(86) PCT No.: PCT/US2017/025746

§ 371 Date: Oct. 4, 2018

Related U.S. Application Data
(60) Provisional application No. 62/317,712, filed on Apr. 4, 2016.

(51) Int. Cl. C03B 27/044; C03B 27/04; C03B 27/012; C03B 23/023; C03B 29/08

(52) U.S. Cl. CPC C03B 27/044; C03B 27/0417; C03B 35/16; C03B 23/0235; C03B 29/08; C03B 27/012

(57) ABSTRACT

Provided herein are methods of heating and tempering glass using a microwave generator, such as a gyrotron. Also provided herein are systems comprising an microwave generator, such as a gyrotron, used to heat glass to a tempering temperature.

### FIELD OF THE INVENTION

Provided herein are methods of tempering glass using microwave energy and related systems for use in tempering glass.

### BACKGROUND OF THE INVENTION

Glass products can be strengthened by any of a number of processes, such as annealing, heat strengthening, and tempering. Typical methods of strengthening glass products involve heating and cooling the glass. Tempering can be achieved by rapidly cooling glass from a high temperature, e.g., greater than 600° C. and typically around 620° C., for example in the range of 627° C. to 704° C. or 1160° F. to 1300° F., to a lower temperature. This is typically achieved by blasting the surface of the glass with high pressure air in a process called “quenching.” The rapid cooling results in a sharp temperature gradient in the glass between the outer surface of the glass and the inside of the glass, with the center of the glass creating tension by pulling away from the cooler exterior surfaces, and the outer surface going into compression. In an alternate method, tempering can be achieved by “chemical tempering,” where ions within the glass surface are exchanged by other, typically larger ions by ion exchange methods, thereby causing the compression in the glass surface. Chemical tempering is less commonly used than quenching, but is more pertinent to thin glass sheets, such as those used in displays.

Flat and bent glass products, such as architectural transparencies or land, air, and water vehicular transparencies, are typically tempered by quenching. During the conventional heat tempering process, glass is heated in a conventional oven (furnace), equipped with conventional infrared (IR) heaters (e.g., coils) and/or convection systems using heated gas. Often, in order to achieve uniform heating of a large sheet in a conventional oven, a reciprocating/oscillating “shake-and-bake” technique is utilized. Despite the ability to control motion of the glass product, oven temperature, and convection, typical three-dimensional (3D) IR heating ovens cannot accurately and rapidly heat all surfaces of a glass product.

Further, IR-based or heated gas-based heating processes heat a glass sheet from the outside-inward, generating a parabolic heat profile in a cross-section of the glass. In order to adequately heat the inside of a glass product by conventional methods, the outside of the glass is often heated at a greater temperature than desired and/or for longer times, increasing the chance for deformities, especially at contact points on the surface of the glass product, for instance at contact points of a bending iron, rollers, or other carrier used to transport glass when it is heated for the purpose of tempering. For example, fully tempered glass that has been made in a horizontal furnace may contain surface distortions. Specifically, while the glass surface is heated to (or near) the softening point, the glass is moved by hard conveyer rollers that create marks on the surface of the glass. In addition, the high temperatures cause the glass to become less flat, i.e., the glass becomes bowed.

In addition, a traditional IR heating furnace cannot accurately control the glass temperature due to the limited heating coils' density and radiation heat distribution in the furnace. The non-uniform glass sheet temperature in combination with the internal temperature gradient of the glass are two reasons for glass tempering distortion exhibited in traditional thermal tempering processes.

Further, many substrates have IR-reflective layers, which further compound the difficulties inherent in heating a glass product by conduction in a conventional oven. Due to the outside-in heating effect of conventional ovens, heating the glass product takes time, which increases with thickness and/or reflectivity of the glass product. Multi-layered substrates and thicker substrates are particularly susceptible to these difficulties.

### SUMMARY OF THE INVENTION

A method of strengthening a glass sheet is provided. The method comprises: heating the glass sheet to a tempering temperature using a microwave beam produced by a microwave generator; and quenching the glass sheet heated to the tempering temperature using the microwave beam to produce a tempered glass sheet.

A method of strengthening a glass sheet is provided. The method comprises contacting the glass sheet with ions with a larger ionic radius than ions in the glass sheet; and heating the glass sheet using a microwave beam produced by an ultra high frequency microwave generator.

A system for production of a tempered glass product is provided. The system comprises: a glass tempering quenching chamber comprising a forced-air manifold and at least one opening; a conveyor system for conveying a glass sheet extending into the quenching chamber; and a microwave generator that produces a microwave beam that intersects a position of a glass sheet carried on the conveyor system adjacent to the quenching chamber such that a glass sheet carried by the conveyor is transferred directly from the position on the conveyor system that intersects the microwave beam into the quenching chamber.

### BRIEF DESCRIPTION OF THE DRAWINGS

FIGS. 1A, 1B and 1C are graphs illustrating a heat profile of a glass sheet heated by outside-in methods (FIG. 1A), and by methods described herein (FIGS. 1B and 1C). “T” refers to the thickness of the glass, with the X-axis (Y=0) being the center of the glass sheet, and temperature increasing on the X-axis from left to right.

FIG. 2 is a graph showing an example of increased temperature of a glass sheet with distance from a trailing edge of the glass sheet.

FIG. 3 illustrates schematically a microprocessor for receiving signals from sensors and acting on the signals according to one embodiment of the invention.

FIG. 4A is a plan view showing the path of a microwave beam of a gyrotron to selectively heat portions of a stack of one or more glass sheets according to one embodiment of the invention. FIGS. 4B and 4C depict a gyrotron beam-splitter as described herein according to embodiments of the invention.

FIG. 5 is a plan view showing the path of a microwave beam of a gyrotron to selectively heat portions of a stack of one or more glass sheets according to one embodiment of the invention.

FIG. 6 is an elevated cross sectional view of a preheating and microwave chamber according to one embodiment of the invention.

FIG. 7 is an elevated cross sectional view of a quenching chamber according to one embodiment of the invention.

FIGS. 8A and 8B are schematic elevation views of tempering systems according to embodiments of the invention.

FIG. 9 is a schematic elevation view of a microwave-assisted chemical tempering chamber according to one embodiment of the invention.

FIG. 10 is a schematic diagram of a glass tempering system according to one embodiment of the invention.

FIG. 11 is a schematic diagram of a glass tempering system according to one embodiment of the invention.

FIG. 12 is a schematic diagram of a glass tempering system according to one embodiment of the invention.

FIG. 13 is a schematic diagram of a glass tempering system according to one embodiment of the invention.

FIG. 14 is a schematic diagram of a microwave based hybrid glass thermal and chemical tempering system according to one embodiment of the invention. Glass is conveyed in the direction of the arrows.

### DETAILED DESCRIPTION OF THE INVENTION

As used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims can vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For ranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Further, as used herein, the term, “over” means on but not necessarily in contact with the surface. For example, a first substrate “over” a second substrate does not preclude the presence of one or more other substrates of the same or different composition located between the first and the second substrates. Plural encompasses singular and vice versa. For example, while the invention has been described in terms of “an” oven, “a” thermocouple, or “a” gyrotron, or “a” gyrotron beam, multiple ovens, thermocouples, gyrotrons, or gyrotron beams can be used. When ranges are given, any endpoints of those ranges and/or numbers within those ranges can be combined within the scope of the present invention. “Including” and like terms means “including but not limited to”. As used herein, spatial or directional terms, such as “left”, “right”, “inner”, “outer”, “above”, “below”, and the like, relate to the invention as it is shown in the Figures. However, it is to be understood that the invention can assume various alternative orientations and, accordingly, such terms are not to be considered as limiting.

The word ‘comprising’ and forms of the word ‘comprising’ as used in this description and in the claims does not limit the invention claimed to exclude any variants or additions.

The methods and systems described herein are useful for tempering glass sheets, including flat glass sheets, e.g. useful as architectural transparencies, or bent glass sheets, e.g. for use as an aircraft transparency. A “glass sheet” refers to a glass structure having a mid-plane and a pair of opposing extended surfaces. By reference to the “skin”, “outside”, or “major surface” of the glass sheet, it is meant to include an outermost surface of the glass as well as a portion directly adjacent thereto. By reference to the “edge” of the glass sheet, it is meant the leading or trailing ends of the sheet or the extended opposing side “minor surfaces” thereof.

The glass sheet can include a single glass layer, multiple glass layers, or coated glass having one or more layers for controlling electromagnetic energy transmission, absorbance, refraction, or reflection, as are broadly-known in the glazing arts. For example, the glass sheet can be opaque, transparent or translucent to visible light. By “opaque” it is meant having visible light transmission of 0%. By “transparent” it is meant having visible light transmission in the range of greater than 0% to 100%. By “translucent” is meant allowing electromagnetic energy (e.g., visible light) to pass through but diffusing this energy such that objects on the side opposite the viewer are not clearly visible. The glass sheet may be a transparent glass sheet. Non-limiting examples of glass materials from which the glass sheet is formed include conventional soda-lime-silica glass, borosilicate glass, and lithia-alumina-silica glass. The glass can be clear glass. By “clear glass” it is meant non-tinted or non-colored glass. Alternatively, the glass can be tinted or otherwise colored glass. The glass may be conventional float glass and can be of any composition having any optical properties, e.g., any value of visible transmission, ultraviolet transmission, infrared transmission, and/or total solar energy transmission. By “float glass” it is meant glass formed by a conventional float process. Examples of float glass processes are disclosed in U.S. Pat. Nos. 4,744,809 and 6,094,942, which patents are hereby incorporated by reference. The glass may be a clear lithia-alumina-silica glass of the type disclosed in U.S. Pat. No. 8,062,749, or the glass may be a clear soda-lime-silica glass of the type disclosed in U.S. Pat. Nos. 4,192,689; 5,565,388, and 7,585,801.

The glass sheet can be used in the manufacture of shaped monolithic or shaped laminated transparencies for an aircraft. However, as can be appreciated, the tempered glass sheets can be used in the manufacture of any type of transparency, such as but not limited to windshields, windows, rear lights, sunroofs and moon roofs; laminated or non-laminated residential and/or commercial windows; insulating glass units, and/or transparencies for land, air, space, above water and under water vehicles.

The microwave energy used in the present invention may be produced by a microwave generator operating at a frequency of at least 100 kHz or at least 1 MHz, or at least 1 GHz (gigahertz), or at least 20 GHz. The term “ultra high frequency microwave generator” is used herein to describe a system for production of microwave electromagnetic radiation of at least 20 GHz. A “gyrotron” is a non-limiting example of an ultra high frequency microwave generator. Other examples of ultra high frequency microwave generators include klystrons or traveling wave tubes as are broadly-known. The ultra high frequency microwave generator has an output wavelength and energy suitable for rapid and precise heating of glass, for example in the range of from 20 GHz to 300 GHz (e.g., corresponding to wavelengths ranging approximately from 1 5 mm to 1 mm), and having electrical power ranging from 1 kW (kilowatt) to 100 kW. Thus, an ultra-high frequency microwave generator having an output ranging from 20 GHz to 300 GHz and a power output of at least 1 kW, at least 5 kW, for example, from 1 kW to 100 kW may be used in the methods and systems described herein. In use, the beam may be pulsed. Pulsed beams may have temporary power outputs, when the beam is active, or greater than 100 kW, but the overall average power output, including active and inactive time periods, typically is 100 kW or lower.

A “beam” of electromagnetic radiation can be coherent, collimated, split, guided (that is, with an electromagnetic waveguide), and/or focused. For ultra high frequency microwave generators, a waveguide, for example a magnetic waveguide, as is known in the art, may be used to produce a beam. A microwave beam may have a diameter ranging from 10 mm to 150 mm. The beam may be continuous or pulsed, for example, having a pulse width of from 1 to 25 seconds, and a cycle time of from 1 minute to 10 minutes. Combinations of continuous and/or or pulsed microwave beams may be used.

A “beamsplitter” is an optical device, such as a cube beamsplitter (two cemented right angle prisms, plate beamsplitters, or a half-silvered mirror that splits a single beam of electromagnetic radiation into a plurality of, and typically two, beams. For example, a beam generated by the ultra high frequency microwave generator, for example a gyrotron, can be split by a beam splitter into two or more beams.

A “conveyor” is any suitable device, system, or mechanism for transferring an object from a first physical location to a second. For example, the conveyor transfers glass sheets, for example flat glass sheets or bent glass sheets, from one location to another. The conveyor may include any necessary elements, such as, without limitation: rollers, stub rolls, motors, actuators, gearing, drive elements, platforms, robotic elements, electronic elements, optical elements, control elements, computers, positional sensors, weight sensors, shakers, frames, and/or guides, that cause, facilitate, and control movement of a glass sheet through the glass tempering and production systems described herein. Conveyors and conveyor systems are broadly-known in the art and further description of the variations thereof are not necessary.

For any element of the method or systems described herein, an element, subsystem, system or device “able to” perform a specific activity, function, task, etc. is configured to, is adapted to, and/or is capable of performing the specific activity, function, task, etc. In such a case, where an element, subsystem, system or device is said to be able to perform a specific activity, function, task, etc., one of ordinary skill will readily understand how to specifically configure, arrange, adapt, install, or connect the element, subsystem, system, or device into the described system.

Due to the ability of the ultra high frequency microwave generator to heat glass, optics, including lenses, mirrors, and beam splitters, may be manufactured from materials that are not heated by the microwave radiation produced by the ultra high frequency microwave generator. First-surface or metal mirrors that reflect the microwave radiation are useful. Transparent substrates can be used within the beam path, e.g., in a beamsplitter, if they are not heated by the gyrotron beam, that is at millimeter wavelengths, and include dielectrics, ceramics, polymers, crystals and composite materials, such as diamond, silica, low-loss solid state dielectrics, low-loss ferrites, or low-loss composites. One of ordinary skill in the optics field can design and/or choose suitable optical components for the beam path.

An “oven” or “furnace” is a chamber in which, in the context of the disclosure herein, a glass product is heated, whether for the purpose of pre-warming, warming, bending, heating for tempering, heating for annealing, or any other purpose. An oven comprises walls that are suitably insulated or shielded, and can be any useful shape, such as a cube or rectangular prism. An oven comprises at least one opening, and may comprise a conveyor passing through the opening and into the oven and configured to carry a glass product into the oven. The oven may comprise a second opening, with the conveyor extending from outside the oven, through the first opening, through the oven and through the second opening. The conveyor can be any useful configuration comprising, for example, rollers that either roll freely or which are driven by a motor, such as a motor controlled by a computer process, to move the glass product along the conveyor. Sensors, such as positional sensors, may be used to monitor a position of a glass product along the conveyor and within the oven, and the movement of the glass product along the conveyor can be controlled manually or by computer control. The position of the glass product on the conveyor may be obtained in the form of positional data produced by a positional sensor, the positional data may be analyzed by a computer process and motors controlling the conveyor may be controlled by a computer process so that the glass product is moved along the conveyor according to a predetermined protocol. An oven typically comprises a door at one or more openings, which can be manually opened or closed, but may be opened and closed by a motor. The opening and closing of the door may be coordinated by an automated method, such as by a computer process, that synchronizes ingress and egress of a glass product by the conveyor into and out of the oven.

An oven may comprise one or more heating elements, such as an infrared, e.g. resistive coil, heating element and/or heated gas heaters. The IR heater may be a high-intensity heating coil, e.g. having a power output of 3.6 W/cm². A heating element may be placed on one or more walls of the oven. In the case of a rectangular prism- or cube-shaped oven, for example, the heating may be three dimensional (3D)—meaning the oven comprises at least two different heating elements on different walls. In order to achieve more even heating of a glass product in an oven, a fan may be employed within the oven to create convection.

It is understood that the invention is not limited in its application to the specific illustrated examples as these are merely illustrative of the general inventive concept. Further, the terminology used herein to discuss the invention is for the purpose of description and is not of limitation. Still further, unless indicated otherwise in the following discussion, like numbers refer to like elements.

### Microwave Heating

The approach to tempering described herein combines traditional glass quenching technology with microwave-based heating to achieve desired glass tempering properties. The unique capability of microwave heating of glass enhances traditional thermal tempering capability for glass panels, improves tempering quality, reduces or eliminates glass distortion, allows for shorter cycle times, and/or allows for an overall cost reduction in the process. A single tempering process may be used to produce high quality tempering on both coated and uncoated glass systems with minimal or no change in process. The same tempering process could be utilized for both coated and uncoated glass.

Unlike conventional electric heating, microwaves can penetrate through glass, thereby heating glass volumetrically and efficiently. Combined with electric (e.g., IR) heat, microwave heating of the present invention generates a desired profile across glass thickness suitable for thermal tempering.

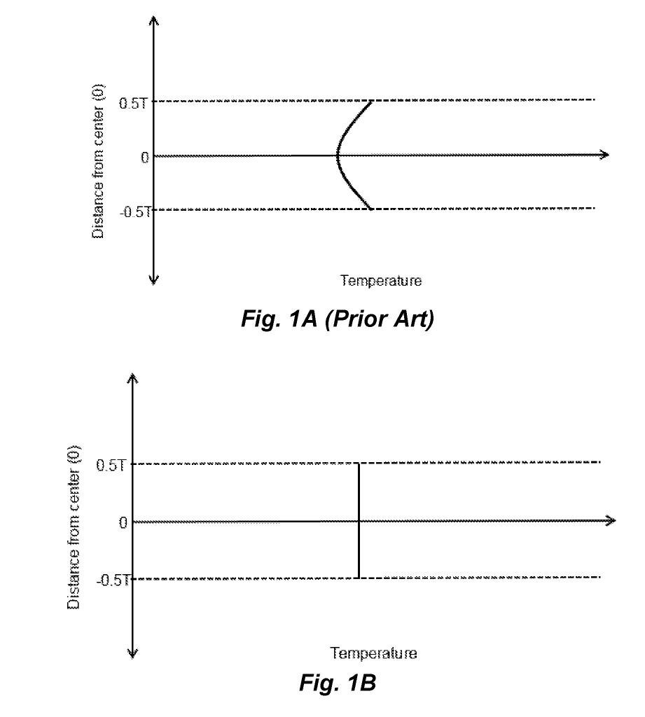

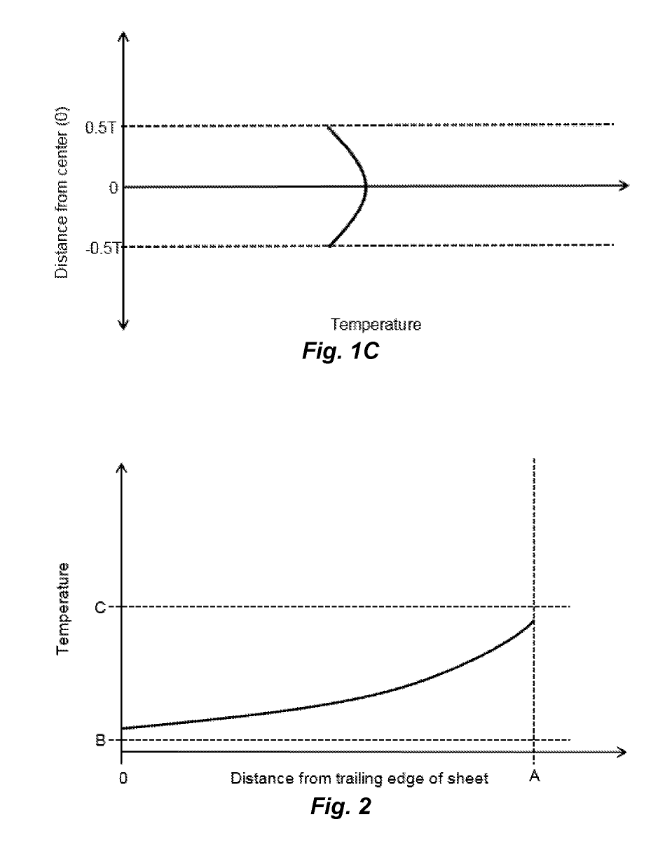

The challenges of glass tempering processes include: to achieve good temper glass quality without losing the shape of the glass, to maintain good optical quality, and/or to minimize the breakage during the glass tempering process. Traditional thermal glass tempering conducted in an IR heating furnace relies on the IR heating furnace to pre-heat the glass to the tempering temperature. However, due to the nature of IR heating, it is difficult to effectively and sufficiently heat the glass sheet mid-plane. In turn, a “negative” parabolic temperature gradient with lower mid-plane temperature (see, e.g., FIG. 1A) is formed in the glass sheet, which limits the maximum glass tempering temperature in the furnace. When glass is thin (e.g., less than 2.5 mm in thickness), it is even more difficult to achieve and maintain the required maximum glass tempering temperature due to rapid heat dissipation. The maximum glass tempering temperature is a factor that will increase the ΔT (the temperature difference between the glass surface temperature and mid-plane temperature), hence the temper strength, including center tension and/or surface compression, of the glass. Microwave heating at a frequency above 20 GHz is able to penetrate the glass surface and heat the glass sheet volumetrically (internally) due to its unique heat transfer mechanisms of, without any intent to be bound by this theory: 1) permanent dipole molecules reorientating under the influence of the microwave energy, and/or 2) conductive currents flowing within the material due to the movement of ionic constituents. A gyrotron can generate high power and high frequency microwave beam to heat glass. Advantages of microwave, e.g. gyrotron, heating include: accurate control, efficient heating, and/or adjustable beam size. A “positive” glass internal temperature gradient, e.g., a parabolic gradient with hotter mid-plane (as in FIG. 1C) may be produced in the glass sheet, thereby improving the glass temper.

A glass sheet will cool off once it leaves the heating oven(s), and in a conveyor system, the leading edge of the glass sheet leaves the oven(s) before the trailing edge, therefore having longer time to cool than the trailing edge before commencement of quenching in the quenching chamber.

Therefore, a glass sheet having a leading edge and a trailing edge may be heated using a microwave beam to a temperature profile where the temperature of the glass sheet rises from the trailing edge to the leading edge (see, e.g., FIG. 2). In FIG. 2, the leading edge of the microwave-heated sheet is indicated by dotted line A, the minimum effective tempering temperature is indicated by dotted line B, and the maximum tempering temperature for the glass sheet is indicated by dotted line C. The temperature differential between the leading edge and the trailing edge and shape of the temperature profile curve from the leading edge to the trailing edge can be selected by controlling the speed at which the glass sheet leaves the heating oven(s) to travel to the quenching chamber, ambient temperatures, and any other environmental and/or process-related factor(s) that contribute to loss of heat from the leading edge of the sheet to the trailing edge. By microwave heating the leading edge to a higher temperature than the trailing edge, as compared to an IR-heated glass sheet, the glass sheet has a uniform temperature profile, or at least a more uniform temperature profile, from the leading edge to the trailing edge by the time quenching begins in the quenching chamber. In one example, the temperature profile of the glass sheet in the quenching chamber from the leading edge to the trailing edge is isothermal, meaning it is flat and/or linear, with less than from 100° C. to less than 1° C. temperature variance from a linear isotherm (a line having a single temperature, that is the tempering temperature in the present context), e.g., 100° C., 90° C., 80° C., 75° C., 70° C., 60° C., 50° C., 40° C., 30° C., 25° C., 20° C., 10° C., 5° C., 1° C. or 0.1° C. variance from a linear isotherm, and increments therebetween.

Provided herein are methods and systems for use in tempering glass sheets, such as flat sheets or bent sheets. The methods and systems provide, e.g., a more uniform heating profile to achieve rapid, uniform tempering of glass products, including shaped and multi-layer products. A method is provided for tempering a glass product that may comprise pre-heating a glass sheet in an oven, heating the glass sheet to a tempering temperature profile using ultra-high frequency microwave radiation, e.g., using a gyrotron, and quenching the glass sheet to produce a tempered glass sheet.

The temperature profile produced by the microwave beam may be substantially flat (e.g., varying by at most ±10° C.) through the thickness of the glass sheet (FIG. 1B). Alternatively, the outer surfaces of the glass may be cooler than the center of the glass sheet (FIG. 1C). To achieve this, the ambient temperature of the oven in which the glass sheet is heated to tempering temperature is lower than the tempering temperature, e.g., the ambient temperature is in the range of from 800° F. to 1000° F. Fans or other air circulation devices may be used to produce convection in the oven while the glass is heated using the gyrotron to produce a temperature profile in which the outer surfaces of the glass are cooler than the interior of the glass. Therefore, a method of heating a pre-heated glass sheet to a tempering temperature also is provided, comprising heating the glass sheet to a tempering temperature where at least a portion of an internal point of the glass sheet is heated to the same or to a higher temperature than an overlying surface point of the glass sheet (a point on the surface of the glass at the same location on the glass sheet, e.g., the same (x,y) coordinate for a planar sheet, and/or where both points are on a line normal to the surface of the glass sheet).

### Systems for Microwave Heating

Systems are provided herein for tempering using microwave heating of a glass sheet to a tempering temperature. Based on the unique feature of the microwave (e.g., gyrotron) heating process, systems and methods may comprise two stages. In the first stage, the glass sheet is heated by the microwave (e.g., gyrotron) system, which, for example, can comprise two chambers (e.g., IR pre-heat and microwave heating chambers) or one chamber, in which the glass sheet is heated by the high power microwave (e.g., gyrotron) system with optional accompaniment of conductive heating, for example using IR heating. In the second stage, a quenching system rapidly reduces the glass temperature to achieve good glass temper quality.

These systems and related methods are applicable to flat or bent glass sheets. For aerospace transparencies, or for other uses where bent glass sheets are produced, the tempering systems described herein optionally directly follow a bending process, which may include microwave bending, to produce a semi-continuous glass bending-glass tempering process. When present, a connected conveyor between the microwave bending process and the tempering system may ensure that the transition of the glass from the microwave bending chamber to the quenching system is proper in terms of the tempering temperature and heat loss. It also can ensure that the transition is reliable and robust. With this approach the cost and total process throughput may be optimized, thereby increasing total output and/or reducing the cost of the manufacturing cost to make the aerospace transparency. The glass sheet may be pre-heated in a first oven, moved to a second oven, heated to a tempering temperature profile with a microwave beam in the second oven, moved to a quenching chamber, and quenched in the quenching chamber. Alternatively, the glass sheet may be pre-heated and then heated to a tempering temperature profile with a microwave beam in a first oven, moved to a quenching chamber, and quenched in the quenching chamber. In either instance, the heating of the glass sheet to the tempering temperature is accomplished using the microwave beam, and optionally with additional infrared heating.

The microwave beam may be applied from above the glass sheet, for example in the case of non-coated glass sheets. Where the top major surface of the glass sheet is coated, for example with a reflective and/or low-emissivity coating, the glass sheet may be heated from below by the microwave beam. More than one microwave beam may be employed to heat the glass sheet, for example when the glass sheet is heated from below, or in any instance where obstructions could block a single microwave beam from effectively heating a complete glass sheet. Providing more than one microwave beam can be accomplished by using more than one ultra high frequency microwave generators, e.g., gyrotron devices, but more economically, and flexibly, a beam splitter may be used to split one microwave beam into two or more beams. For example, when a glass sheet is heated from below, for instance where an upper surface of the glass sheet has a reflective coating, elements of the conveyor or frame carrying the glass sheet might interfere with the coverage and heating of the entire surface of the glass sheet with a single microwave beam. In another case, for example with larger glass sheets, a single microwave beam may be less effective to heat the glass sheet adequately or evenly for tempering purposes. In these cases, a beam splitter, e.g., as described herein, may be employed to provide multiple microwave beams.

The following further describes various non-limiting examples of the devices, methods, and systems described herein.

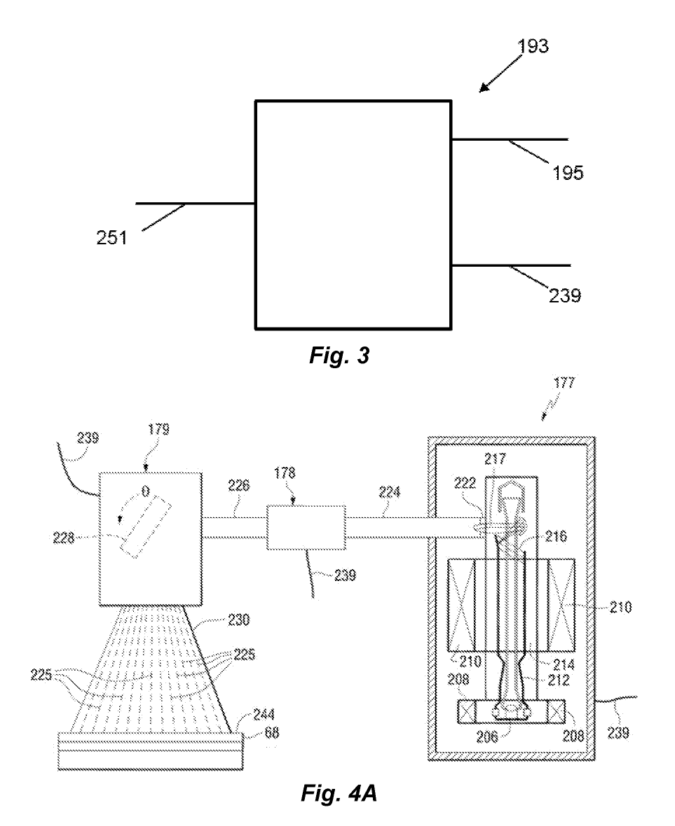

Control systems for transferring sheets from station to station in the treatment of glass, e.g. in the tempering of glass, including but not limited to motion of the glass sheet, opening and closing doors of ovens, quenching chambers, microwave chambers, chemical tempering chambers, bending chambers, and/or other chambers may be controlled manually or by a computer. A computer comprises a microprocessor system that includes a microprocessor that processes instructions for performing a task. Instructions may be programmed in any suitable programming language, and may be used to monitor, control, and/or report on, e.g., various mechanical, electrical, or optical aspects of the systems described herein, including, for example and without limitation: monitoring and/or controlling temperature of a sheet or oven, monitoring and/or controlling of position of a sheet, monitoring and/or controlling shape of a sheet, monitoring and/or controlling heating of a sheet for tempering, and/or monitoring and/or controlling quenching of a sheet. For example in reference to FIG. 3, thermocouples in an oven may forward a signal to a computer microprocessor system 193 (see FIG. 3). The computer microprocessor system 193 acts on the signal to determine the temperature of the interiors of the furnaces, respectively. If the temperature of a furnace interior is below a set temperature, a signal is forwarded along line 195 to increase the heat input of the furnace. On the other hand, if the temperature of a furnace interior is too high, a signal is forwarded along the line 195 to decrease the heat input to the furnace. If the temperature of the furnace interior is in an acceptable range, no action is taken. Non-limiting examples of sensor components of the systems described herein include pyrometers, thermocouples, thermal scanners, positional sensors and scanners, and other sensors as are known in the art for use in measuring temperature, shape, position or any other useful attribute of the treated glass sheet or the system used to process the glass sheet as described herein.

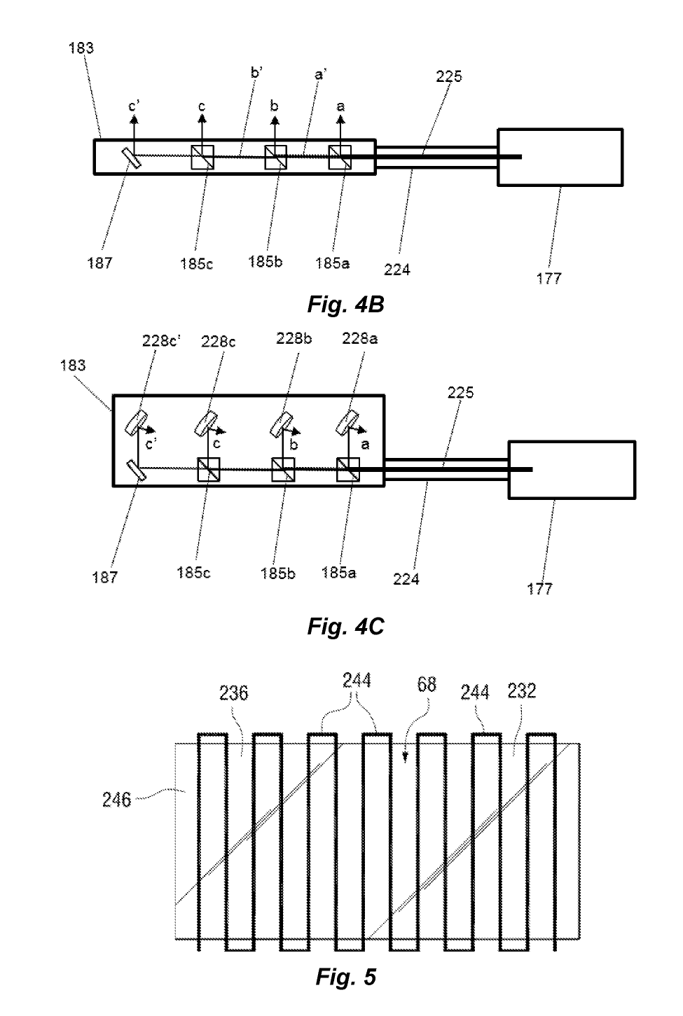

FIG. 4A is a schematic partially in cross section showing a gyrotron that can be used in the present invention to heat selected portions of a glass sheet. A gyrotron includes a high-powered linear beam vacuum tube capable of generating high-power, high-frequency electromagnetic radiation approaching the edge of the infrared terahertz (THz) spectrum. Its operation is based on the stimulated cyclotron radiation of electrons oscillating in a strong magnetic field, e.g. as provided by a superconducting magnet. As above, any suitable microwave generator capable of generating high-power, high-frequency electromagnetic waves, such as a microwave generator having an output frequency ranging from 20 GHz to 300 GHz, and having a power output of at least 5 kW, is suitable. A schematic, indicating the various parts of a gyrotron 177 is shown in FIG. 4A. In general and not limiting to the invention, in the operation of the gyrotron 177, electrons that are emitted by a cathode 206 surrounded by gun coil magnets 208, are accelerated in a strong magnetic field of a superconducting magnet 210. While an electron beam 212 travels through the intense magnetic field 210, the electrons start to gyrate at a specific frequency given by the strength of the magnetic field. In a cavity 214, located at the position with the highest magnetic field strength, the THz radiation is strongly amplified. Mode converter 216 is used to form free-gaussian beams 217 that leave the gyrotron 177 through a window 222 and is coupled to a waveguide 224. Gyrotrons are commercially available from, e.g., Gyrotron Technology, Inc. of Philadelphia, Pa.

With continued reference to FIG. 4A, the free-gaussian beams 217 pass through the waveguide 224 to the optical box 178. The optical box 178 has mirrors (not shown) arranged to collimate the free-gaussian beams 217 into a single beam 225 and control the size, e.g. the diameter, of the beam 225. The collimated beam 225 leaves the optical box 178 through waveguide 226 and passes into the mirror box 179. The mirror box 179 has one or more moveable mirrors 228 (one mirror shown in phantom in FIG. 4A) to move the beam 225 through a predetermined area defined by a zone 230 (see FIG. 4A). In FIG. 4A, the beams 225 moving through the zone 230 are incident on a flat glass sheet 68.

FIG. 4B is an elevation view, schematically showing a variation of a device as depicted in FIG. 4A, utilizing a beam splitter. In FIG. 4B, gyrotron 177 produces a beam 225. The beam 225 passes through a waveguide 224 into a beam splitter assembly 183. The beam splitter assembly is depicted as comprising three beam splitters 185a-c. Beam splitter 185a splits beam 225 into beams a and a′, with a being directed upwards vertically and being 25% of the beam 225, and hence 25% of the output of gyrotron 177, and a′ being 75% of the beam 225. Beam splitter 185b splits beam a′ into beams b and b′, with b being directed upwards vertically and being 25% of the beam 225, and b′ being 50% of the beam 225. Beam splitter 185c splits beam b′ into beams c and c′, with c being directed upwards vertically and being 25% of the beam 225, and c′ being 25% of the beam 225. Mirror 187 directs beam c′ upwards vertically towards a glass sheet. Beam splitters 185a-c and mirror 187 may be fixed in place, or one or all of beam splitters 185a-c and mirror 187 may be collectively or independently computer-controlled to direct beams a, b, c, and/or c′ onto a surface of a glass sheet.

Additional fixed or moveable and computer-controlled optics may be selected and employed by one of ordinary skill in the art to direct and/or modify beams a, b, c, and/or c′, as is needed to be able to adequately heat a glass sheet. FIG. 4B depicts splitting of a beam 225 into four equal beams a, b, c, and c′, each having 25% of the original beam's energy. As would be recognized by one of ordinary skill in the art, the beam can be split into any number of sub-beams, for example 2, 3, 4, 5, 6, 7, 8, 9 or 10 sub-beams, so long as the sub-beams can be utilized to heat a glass sheet. Additional or fewer beam splitters, as shown for example in FIG. 4B, may be employed for that purpose. A person of ordinary skill can determine appropriate optical elements for use in the beam splitter assembly 183.

FIG. 4C is an overhead view, depicting schematically a modification of the device of FIG. 4B, in which additional optics for directing beams a, b, c, and c′ are present. In FIG. 4C, as in FIG. 4B, gyrotron 177, waveguide 224, beam 225, beams a, b, c, and c′, beam splitter assembly 183, beam splitters 185a-c, and mirror 187 are depicted. Additional mirrors 228a, 228b, 228c, and 228c′ are depicted. Beams a, b, c, and c′ are directed horizontally by beam splitters 185a-c, and mirror 187, and are then reflected upwards vertically by mirrors 228a, 228b, 228c, and 228c′, in the same direction (towards a glass sheet) as shown in FIG. 4B. Each of mirrors 228a, 228b, 228c, and 228c′ may be independently fixed in position or collectively or independently controllable and controlled by a computer to direct beams a, b, c, and c′ to specific location(s) on a glass sheet. For computer control of any of mirrors 228a, 228b, 228c, and 228c′ of FIGS. 4A and 12C, suitable actuator devices, such as motors or control elements, and communications modules, wired or wireless, may be employed as is appropriate to control the position of the mirrors 228a, 228b, 228c, and 228c′.

As would be recognized by one of ordinary skill, in reference to FIGS. 4A and 4B, gyrotron 177, waveguide 224, beam splitter assembly 183, beam splitters 185a-c, mirrors 228 and 187, mirror box 179 and any other elements of those devices can be mounted on an oven, furnace, chamber, etc. in any useful configuration, so long as the device can effectively heat a glass sheet.

The microprocessor or computer system 193 (FIG. 3) may be programmed e.g., but not limited to, a signal sent along wire 239, to control the operation of the mirrors of the optical box 178 (FIG. 4A) to set the size of the beam 225 incident on the portions of the glass sheets being shaped, the movement of the mirror 228 of the mirror box 179 to control the direction of movement and speed of movement of the beam 225 or beams a, b, c, and c′ in the zone 230 (see FIG. 4A), and the energy of the beam 225 by altering the anode voltage, strength of the magnetic field and/or the voltage applied to the system of the gyrotron 177. With reference to FIGS. 3, 4A and 5, as needed, the mirror 228 operated by the microprocessor 193 moves the beam 225 along a predetermined path 244 on surface 246 of the top glass sheet, e.g. top glass sheet 68 facing the mirror box 179. The energy beam 225 as it moves along the path 244 in the area of the sheets designated by the number 236, heats the glass sheets to their tempering temperature for the glass sheets. The energy beam 225 as it moves along the path 244 in the area of the sheets designated by the number 232 (see FIG. 5) heats the glass sheets to their tempering temperature. Pyrometers or other temperature sensors or scanners may be used to monitor the temperature of the glass. The temperature sensors or scanners may be connected to the microprocessor or computer 193 by wires 251 to send a signal to the microprocessor 193, and the microprocessor may forward a signal along the wire 239 to maintain the temperature of the selected portions of the glass within a desired temperature range by altering the speed of the beam 225 along the path 244 and/or by altering the energy of the beam as discussed above. More particularly, decreasing the speed of the beam 225 increases the temperature of the glass and vice versa, and increasing the anode voltage, the magnetic field, and/or the applied voltage, increases the temperature of the glass, and vice versa. Movement of the beam along the glass sheet may be accomplished by directing the beam 225, as shown, but also may be accomplished by or assisted by movement of the glass sheet, e.g. by oscillation of the glass sheet. The beam may be moved along the glass sheet in any useful pattern and/or as needed based on temperature scanning of the glass sheet to raise, lower, or maintain the temperature profile over the entire glass. The target temperature profile for the glass sheet may be entered and stored in a suitable non-transitory computer-readable medium, sensor input from temperature sensors or scanners may be compared to the target temperature profile using the microprocessor, and the microwave beam may be directed to portions of the glass sheet by the microprocessor to match the actual temperature of the glass sheet to the target temperature profile.

The obtaining and processing of thermal data, and the use of those data to produce temperature profiles may be repeated one or more times during the heating process, e.g., at intervals ranging from every 0.0001 to 60 seconds, including every 0.0001, 0.001, 0.01, 0.1, 0.5, 1, 2, 5, 10, 15, 20, 30 and 60 seconds including any increment therebetween. Even shorter time intervals are contemplated, and are only limited by the throughput (e.g., processing power) of the computer system. The gyrotron system may not be able to respond to the computer system as quickly as the computer system can analyze data, so scanning intervals may be set based on the responsiveness of the gyrotron system. That said, the scanning and analyzing of thermal and optionally spatial profiles may be performed at faster rates than the controlling of the gyrotron, within limits of the pertinent hardware.

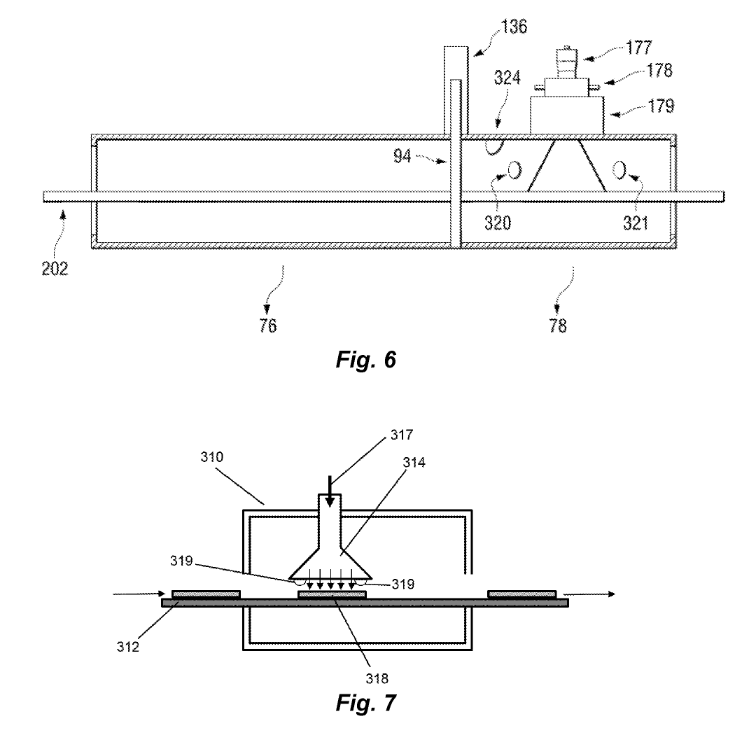

FIG. 6 shows schematically an example of a furnace system. FIG. 6 includes a first chamber 76, a microwave heating chamber 78, a door 94 supported by a U-shaped member 136, a thermal sensor 324, and positional sensors 320 and 321. The first chamber 76 preheats, through the use of infrared heaters, a glass sheet carried on conveyor 202, e.g., to a temperature within the range of 900-1000° F., although other suitable preheat temperatures may be utilized depending on the material of the glass sheet. The microwave heating chamber 78 heats portions of the flat glass sheets to achieve a desired tempering temperature. Infrared heaters of the second chamber 78 maintain the temperature of the chamber to 1000-1100° F., or any temperature just below a shaping or sag temperature of the glass sheet. The sheet of glass is heated in the microwave heating chamber 78 by a gyrotron beam system, including a gyrotron 177, an optical box 178, and a mirror box 179.

In operation of the systems and methods described herein, a glass sheet is first prepared and is optionally bent to a desired shape. When the sheet is otherwise ready for tempering, the sheet is tempered using the systems described herein, and/or the methods described herein. The glass sheet is moved into a furnace in which it may be preheated and then, either within the same furnace chamber or in another chamber or station, is heated to a tempering temperature profile using the microwave heating method and systems as described herein. The glass sheet heated to the tempering temperature profile using the microwave beam is then quenched to produce a tempered glass sheet. That is, the glass sheet is heated to a tempering temperature profile using a microwave beam, and although the temperature profile of the glass sheet may change before quenching is initiated, the glass sheet remains at a suitable tempering temperature between the microwave heating to a tempering temperature and the initiation of rapid cooling during quenching. As would be understood by those of ordinary skill in the art, the respective configuration and relative locations of the preheating oven, the microwave beam, and quenching chamber can be varied, so long as adequate and acceptable heating and quenching can be accomplished. The quenching may directly follow the heating, meaning there is little or no further treatment of the glass sheet between microwave heating to a tempering temperature and quenching, but any intervening treatment may be utilized that does not negatively interfere with the described microwave heating to a tempering temperature and quenching of the glass sheet heated to the tempering temperature using the microwave beam to produce a tempered product. In the system described herein, the microwave generator may be adjacent to the quenching chamber, meaning there is little or no further treatments of the glass sheet between a position on a conveyor system where the microwave heating to a tempering temperature takes place, and the quenching, but any intervening treatment may be utilized that does not negatively interfere with the described microwave heating to a tempering temperature and quenching of the glass sheet heated to the tempering temperature using the microwave beam to produce a tempered product.

Glass is tempered by rapidly-cooling the surface of the glass sheet with a stream of gas or air, e.g., compressed air, in a process known as quenching. FIG. 7 depicts a quenching chamber 310. Quenching chamber 310 may be any useful shape, as with the ovens. A glass sheet may be conveyed into and out of the quenching chamber 310 using a conveyor 312, as described elsewhere herein. The depicted exemplary quenching chamber 310 comprises a forced-air manifold 314, which is connected to an air source, such as a tank of compressed air. In use, air 317 is forced through the forced-air manifold 314, onto a glass sheet 318. Movement of the glass sheet 318 by the conveyor 312 is at least in one direction, depicted as left to right (see arrows) in FIG. 7, but may be in any direction to best quench the glass sheet or otherwise optimize the tempering and/or overall production process. Physical structures and/or computer controllers, e.g., robotics, may control movement of the glass sheet in two or three dimensions, and control of such movement, may be readily accomplished by one of ordinary skill in the art. Temperature of the glass sheet 318 may be measured as described herein, by IR scanners or imaging. Imaging (e.g. charge-coupled device or CCD) or temperature sensors 319 are depicted as being placed on the manifold 314. Alternatively, or in addition to placement on the manifold 314, imaging and/or temperature sensors 319 may be placed in gaps in the conveyor 312 (e.g., in gaps between stub rolls), or below the conveyor 312, so long as the sensor(s) 319 can scan the glass sheet 318 adequately for the purpose of measuring the temperature of the glass sheet 318. The quenching chamber 310 optionally includes one or more doors (not shown), e.g., as described in various examples of the ovens described above, to partially or completely close the openings through which the conveyor and glass sheets pass as the glass enters and/or exits the quenching chamber 310. Any or all aspects of the quenching process, such as air flow, glass sheet movement, and/or air temperature, may be monitored and controlled by a computer system, for example according to a predetermined protocol stored on and implemented by the computer, alone, or in conjunction with analysis of a temperature profile of the glass sheet, obtained, e.g., by scanning or imaging, prior to and/or during quenching, and comparing that temperature profile to a stored temperature profile in a computer system, and adjusting any quenching parameter, such as movement of the glass sheet on the conveyor, air flow through the manifold, and/or quenching air temperature though the manifold until the stored temperature profile is met. The stored temperature profile may include at least a temperature of the glass sheet, but also may include a rate of change of temperature of the glass sheet from the tempering temperature.

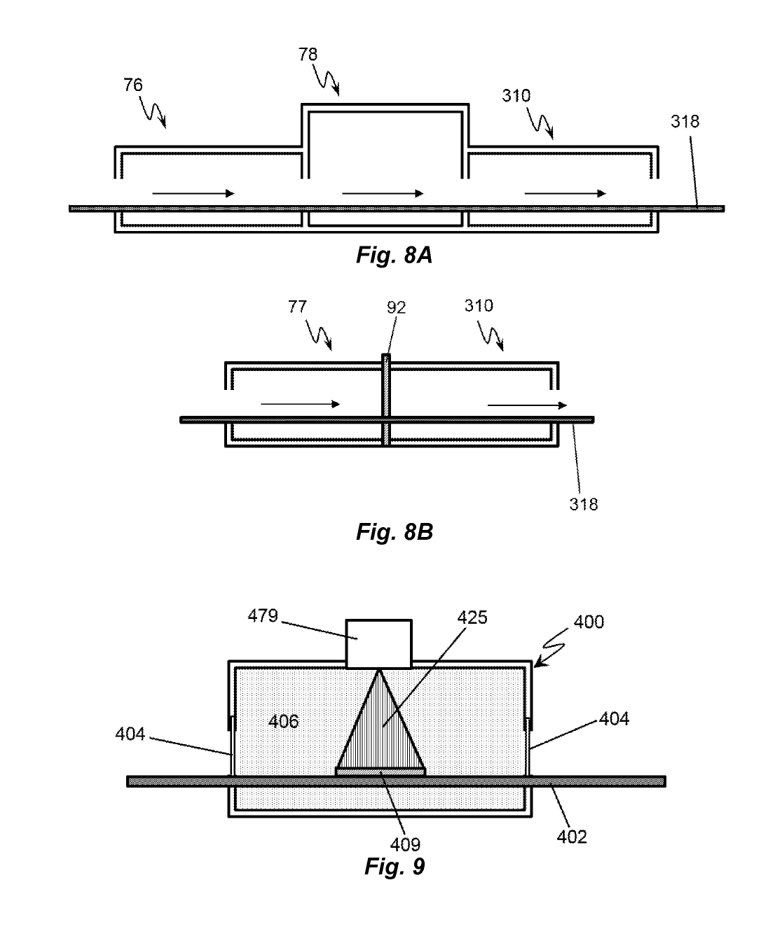

FIGS. 8A and 8B are schematic drawings showing two version of generalized layouts of tempering systems as described herein. FIG. 8A provides a system useful in tempering a glass sheet as described herein, depicting the orientation of a first chamber 76 providing preheating using, e.g. IR heating, a second chamber 78 for use in microwave (e.g., gyrotron) heating of the glass sheet to a tempering temperature, and a quenching chamber 310, with arrows showing the general direction of movement through the chambers along conveyor 312. FIG. 8B provides a schematic elevation view of an alternate version of the system of FIG. 8A, in which first oven 77 combines IR pre-heating and a gyrotron system for heating a glass sheet, and a quenching chamber 310, separated by a door 94, which is shut when first oven 77 or quenching chamber 310 are in operation, but opens during transfer of a glass sheet from the first oven 77 to the quenching chamber 310.

In an alternative to heat tempering, glass sheets, and particularly thinner glass sheets, may be chemically tempered. Chemical tempering is achieved by ion exchange between smaller ions in the glass, such as sodium or lithium ions, with larger ions, which cause the characteristic compression effect found in tempered glass. Traditional chemical tempering methods are broadly-known, and involve exposing a glass sheet comprising smaller ions to a solution comprising the larger ions. For example sodium ions in sodium-containing glass are exchanged for potassium ions in a bath of potassium nitrate, or lithium ions in lithium-containing glass are exchanged for sodium ions in a bath of sodium nitrate. A chemical strengthening process is provided herein. In the method, a glass sheet is contacted with, or otherwise exposed to ions with a larger ionic radius than ions in the glass sheet, for example the glass sheet is contacted with a vapor comprising ions with a larger ionic radius than ions in the glass sheet, while concurrently heating the glass sheet with a beam from an ultra high frequency microwave generator, such as a beam from a gyrotron. A chemical deposition chamber 400 is depicted schematically in FIG. 9. Chamber 400 is depicted with a conveyor 402 as described elsewhere herein, doors 404, and chemical vapor 406. Examples of chemical vapors include any composition useful in chemical tempering, such as a vapor providing alkaline metal ions larger than those present in the glass prior to tempering. The chamber 400 also comprises a gyrotron mirror box 479, which is attached to a gyrotron (not shown) as described elsewhere. The gyrotron produces a beam 425, which heats a glass sheet 409, accelerating the ionic exchange process and, without any intent of being bound by this theory, permitting deeper penetration of larger ions than is achievable by traditional salt baths. In an alternate embodiment, standard chemical tempering may be conducted by ion exchange in a suitable bath, and the gyrotron beam may be used to heat the glass during or after the ion exchange process to facilitate the chemical tempering process. This is expected to provide a stronger product and also allows for chemical tempering of thicker glass sheets than would be possible using traditional salt baths.

The methods and systems described herein may rely on a computer, for example like, but not limited to, a microprocessor 193, at least for monitoring and controlling progress of the heating and tempering the glass sheets as described herein. A computer or computer system may take any physical form, such as a personal computer (PC), credit card-sized computers, personal digital assistant (PDA), smartphone, tablet, workstation, server, mainframe/enterprise server, and/or clusters. The terms “computer”, “computer system”, “microprocessor system”, or “computer microprocessor system” are herein used interchangeably. A computer includes one or more processors, e.g. a central processing unit (CPU), which carries out instructions for the computer. A computer also includes memory, e.g., RAM and ROM (storing, e.g., the UEFI or BIOS), connected to the processor by any suitable structure such as a system bus. Computers also may comprise non-transient storage for storing programming and data, in the form of computer readable medium/media, such as, for example, a hard drive, a solid state drive (SSD), an optical drive, a tape drive, flash memory (e.g., a non-volatile computer storage chip), a cartridge drive, and control elements for loading new software. Computer systems as described herein are not limited by any topology or by the relative location of the various hardware elements, recognizing the varied physical and virtual structures those of ordinary skill employ in implementing a computer system.

Data, protocols, controllers, software, programs, etc., may be stored locally in the computer, e.g., in a hard drive or solid state drive (SSD); within a local or wide-area network, or cloud, e.g., in the form of a server, a network associated drive (NAS); or remotely, such that connection is made over an internet connection, e.g., via remote access. Data, such as images, temperature profiles or shape profiles produced or used by the methods and systems described herein may be organized on computer readable media in a database, which is an organized collection of data for one or more purposes. Other exemplary hardware that form elements of a typical computer, include input/output devices/ports, such as, without limitation: Universal Serial Bus (USB), SATA, eSATA, SCSI, Thunderbolt, display (e.g., DVI or HDMI) and Ethernet ports, as are broadly known, and graphics adaptors, which may be an integral part of the CPU, a subsystem of the motherboard, or as separate hardware device, such as a graphics card. Wireless communications hardware and software, such as Wi-Fi (IEEE 802.11), Bluetooth, ZigBee, etc. may also be included in the computer. Elements of a computer need not be housed within the same housing, but may be connected to a main computer housing via any suitable port/bus. In a typical computer, at least the CPU, memory (ROM and RAM), input/output functionality, and often a hard drive or SSD and a display adaptor may be housed together and are connected by a high-performance bus of any useful topology.

The computer, having storage and memory capabilities, includes controller aspects that allow for the design, storage, and execution of instructions, executable by a processor for independently or collectively instructing the computer system to interact and operate as programmed, referred to herein as “programming instructions”. In the context of computing, a computer-implemented process (e.g., program), broadly speaking, refers to any computer-implemented activity that generates an outcome, such as implementation of a mathematical or logical formula, operation, and/or algorithm.

One example of a controller is a software application (for example, basic input/output system (BIOS), unified extensible firmware interface (UEFI), operating system, browser application, client application, server application, proxy application, on-line service provider application, and/or private network application) installed on the computer system for directing execution of instructions. The controller is a WINDOWS™-based operating system. The controller may be implemented by utilizing any suitable computer language (e.g., C\C++, UNIX SHELL SCRIPT, PERL, JAVA™′ JAVASCRIPT, HTML/DHTML/XML, FLASH, WINDOWS NT, UNIX/LINUX, APACHE, RDBMS including ORACLE, INFORMIX, and MySQL) and/or object-oriented techniques.

The controller may be embodied permanently or temporarily in any type of machine, component, physical or virtual equipment, storage medium, or propagated signal capable of delivering instructions to the computer system. In particular, the controller (e.g., software application, and/or computer program) may be stored on any suitable computer readable media (e.g., disk, device, or propagated signal), readable by the computer system, such that if the computer system reads the storage medium, the functions described herein are performed.

The computer may contain and implement a “protocol”, for example instructions and data that control e.g., the tempering process for a glass sheet. Various modeling techniques may be used to develop protocols and may be implemented as part of a computer-implemented protocol. Modeling techniques include scientific and mathematical models, specific for glass tempering and optionally bending processes, which are able to determine the required temperatures at different stages of the process necessary to achieve a final glass sheet of high-quality. Protocols include, for example, the preheat temperature at the exit of the first furnace, glass forming/bending temperature profile in the glass forming furnace, exit glass temperature once the forming process is complete, glass tempering preheating profile, and the glass tempering temperature profile. The protocol may control the gyrotron beam system to establish a heating profile to achieve a specific heat profile to temper a glass sheet. A gyrotron beam may be manipulated in various ways, such as by altering the path, speed, width, shape, frequency, dwell time at a location (position on the glass sheet), or intensity/energy (e.g., kilowatts, kW) of the gyrotron beam. In one example, beam width, beam shape, intensity/energy and/or frequency may be held constant, but the location, path, speed, and/or dwell time at a location of gyrotron beam may be altered to provide a desired heating profile on the glass sheet. In another example, the gyrotron beam's electrical power may be manipulated, while the beam may be moved at a constant speed across the surface of the glass sheet to produce a desired heat profile. In another example, both the electrical power and beam speed may be changed to achieve the desired effect. The protocol may comprise instructions at least for controlling any or all possible parameters of the gyrotron beam, such as: location, path, intensity/energy, speed, beam shape, beam diameter, and output frequency, which may be controlled by the gyrotron unit or the post-gyrotron optics. For example, the mirrors described herein in connection with the gyrotron (FIG. 4A), or beam splitter (FIG. 4C), when controllable by a computer, may be moved by actuators, motors, servos, etc., to direct a beam onto a position on a glass sheet. In one aspect, data relating to the position of the beam and the heat profile of the glass sheet may be obtained using, e.g., temperature sensors, imaging sensors, IR scanners, positional sensors, or combinations thereof, and such data may be compared to a stored protocol in the computer, and the computer then controls IR heaters, microwave beam(s), glass sheet positional controls, quenching air flow and temperature, and any other relevant aspect of the operation of the systems described herein, to control the heating and movement profile of the glass sheet. As such, a protocol may control the heat-profile and/or heat distribution on a glass sheet for attaining a desired tempering temperature profile for a sheet of glass.

As part of the protocol, the computer may receive and process real-time data from the thermal and positional sensors, particularly the thermal sensor and, optionally the positional sensors. The computer then may produce a temperature profile, and optionally a shape profile, from the real-time data. The temperature profile and shape profile are merely representations in the computer that can be compared to reference temperature and, when applicable, shape profiles stored in association with the bending protocol. The computer system may compare produced profiles to the reference profiles to determine differences between the produced profiles and the reference profiles at one or more locations on the glass sheet, and, if differences are present and one or more positions on the glass sheet require heating to match the temperature and shape of the glass sheet to the reference profiles, the computer may control one or more parameters of the gyrotron beam to selectively heat a portion of the glass sheet to correct those differences. In addition to the above, optionally, the computer may receive additional temperature data from one or more temperature sensors, such as thermocouples and/or IR scanners of one or more chambers and/or furnaces of the system according to any examples described herein, and may act as a thermostat, monitoring and adjusting the ambient temperature of the chamber, e.g., by adjusting the output of IR heaters, blowers, etc. utilized in the system. In one example, thermocouples detect the temperature of the microwave heating chamber 78, as shown in FIG. 6. If the microwave heating chamber 78 is not at the desired temperature, the computer, using computer-implemented processes for example as described above, compares the actual ambient temperature of the microwave heating chamber 78 to a stored reference ambient temperature for the microwave heating chamber 78, and automatically adjusts the heat of the microwave heating chamber 78 in order to reach the stored reference ambient temperature. By “ambient temperature” in reference to the furnaces described herein, it is meant the temperature of the atmosphere at one or more points within the furnace, and does not refer to the temperature of the glass sheet.

The thermal sensor 324 (FIG. 6) may be an IR laser-light sensor that captures an IR image of the glass sheet to be tempered, which is sent to the computer, which compares the captured image to a reference image stored as part of a glass tempering protocol for the particular glass sheet, and, if a position on the glass is at a temperature lower than that of the same position in the image stored as part of a glass tempering protocol, the gyrotron beam may be directed to heat that position until the temperature of the position matches the reference temperature of the image stored as part of a glass tempering protocol. A protocol for producing a specific tempering result from a glass sheet may contain one or more reference temperature distribution profiles for the glass sheet at one or more time points during the heating and/or tempering process.

Positional sensors may be used to track motion and/or shape of the glass sheet within any system described herein. Where pertinent and needed to permit positional monitoring of the glass sheet, a suitable light source to provide illumination of the glass sheet to the extent necessary to permit imaging also may be employed, though heated glass typically emits enough light, e.g. at an IR or visible wavelength, for imaging purposes. The positional sensor(s) may comprise a single unit or multiple units that allow for either image capture or capture of data in real time, indicating the spatial position of one or more positions on the glass sheet. A non-limiting example is a positional sensor obtained from Rockwell Automation (Allen Bradly), for example, the 42 CM 18 mm LaserSight or the 42EF LaserSight RightSight are suitable positional sensors. The positional sensor may be an imaging sensor, such as one or more CCD and/or laser-light sensor devices housed either together or at separate locations within the heating or quenching chamber. CCD and/or laser-light sensor devices sensor devices output 2D images that may be processed within the computer or within the device. The images may be used in their 2D form, or can be processed to form a 3D image by the computer to produce a profile of the glass sheet that indicates the real-time spatial position and temperature of any portion or point on the glass sheet, and then compares that profile to a reference profile associated with the protocol, and adjusts heating with the gyrotron beam to match the profile of the glass sheet with a reference profile. A large variety of position, distance, measurement, displacement, profile, 2D, and 3D sensors, e.g., laser sensors, are commercially available, for example and without limitation from Rockwell Automation (Allen Bradly), Emerson Electric of St. Louis Mo., Schmitt Industries, Inc. of Portland Oreg., and Omron Automation & Safety of Hoffman Estates, Ill. In any case, the positional sensor may be connected to the computer, and data obtained from the positional sensor, optionally in coordination with the IR data described above, may compared to reference data associated with a protocol for tempering a particular glass sheet, and the temperature of any portion of the glass sheet may be adjusted using the gyrotron beam.

A composite 3D image or set of images of the glass sheet at any given time point may be generated by a computer implemented process so as to evaluate the shape or temperature of the glass sheet at any time point. The computer system generated 3D image, composite image, or set of images of the glass sheet and/or a portion thereof can be compared to values of the reference profile of the protocol, and if a deviation from the desired temperature profile stored in the protocol is present, the computer system controls the gyrotron 177 and/or ambient temperature of the second furnace 78, optionally in combination with infrared image data from an infrared imaging sensor to heat the glass sheet, or portions thereof, to shape the glass sheet to meet the requirements of a tempering protocol.

A “temperature profile” or “temperature distribution profile” refers to the temperature of any portion or portions of a specific glass sheet at any time point or points during the process of heating, bending, tempering, and cooling that sheet of glass. As used herein, a “reference temperature profile” refers to a temperature distribution profile for any specific glass sheet stored locally in or remotely from the computer system in association with a protocol for tempering that specific glass sheet. The reference temperature profile is created or developed by any method, such as by formula and/or trial-and-error, to produce a specific tempering of the specific glass sheet. The reference temperature distribution profile for producing a desired tempering of a glass sheet will depend on a variety of factors, including, among other factors: the composition of the glass sheet, the physical (conveyor) path between the heating station and the quenching chamber, and the desired tempering effect. By using a predetermined temperature profile as a reference, and ultimately manipulating the gyrotron system to selectively heat the sheet of glass, a desired tempering temperature distribution may be produced not only inside of the glass, but throughout the glass. The terms “tempering profile” refers to the temperature distribution of a glass sheet at any time point or points during the process of heating, tempering, and cooling a sheet of glass during the tempering process.

The use of safety equipment to limit or prevent damage to the persons operating the equipment, and/or to prevent or limit damage to the equipment is contemplated. For example and not limiting to the discussion, the equipment might include an arc detector. The arc detector may be mounted in the furnace and includes a photocell connected to the microprocessor 193 by way of a cable. The arcing, as is known in the art, is ionized matter, e.g. but not limited to an air born pocket of dust appearing as a burst of light. The arcing phenomenon is well known in the art and no further discussion is deemed necessary. The photocell of the detector senses the arcing and forwards a signal along the cable. The microprocessor 193 forwards a signal along the cable to shut the gyrotron down to prevent damage to the personnel around the furnace and to the gyrotron equipment.

The systems of the invention described herein are provided as illustrative of various aspects of the invention.

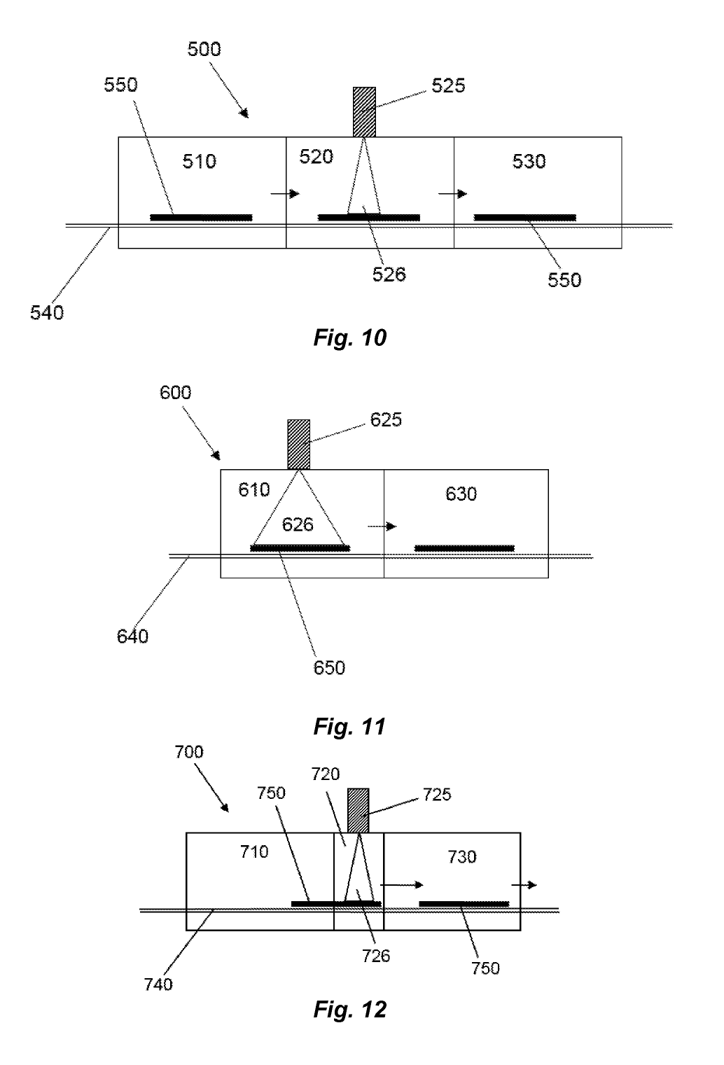

One system 500 is provided as depicted schematically in FIG. 10, and a conveyor 540 with glass sheets 550. One or more doors (not shown) may be included at least between microwave chamber 520 and quenching chamber 530. The glass material is first heated in the preheating chamber 510 by traditional IR heating or gas hearth (by convective heated gas flow) heating. The microwave chamber 520 includes an ultra high frequency microwave generator 525, such as gyrotron, which produces a beam 526 that is used to heat the glass 550 to a tempering temperature profile. The microwave device (gyrotron 525) may be installed on the top of the microwave chamber 520, directing beam 526 downward, but, as with any aspect described herein, may be installed at the bottom, with the beam 526 directed upward, or at any effective point in relation to the chamber 520. In this example, the glass 550, once heated to a desired tempering temperature profile, is transferred to the a quenching chamber 530, where the glass is quenched by a controllable cooling system, which may comprise the nozzle system and compressed cooling air system, essentially as shown in FIG. 7. The three-stage system provides a simple production flow which can be easily adopted into any production system. In order to achieve optimal heating on the glass sheet, the microwave energy may be collimated into a beam with the diameter between 10 mm to 150 mm. This focused beam may be used as a scanning beam across the surface of the glass with a defined power profile to achieve optimal glass heating in three dimension.

A system 600 is provided as depicted schematically in FIG. 11. The system 600 includes an infrared preheating chamber 610, with a gyrotron 625 and a gyrotron beam 626, a quenching chamber 630, e.g., as shown in FIG. 7, and a conveyor 640 with glass sheets 650. A door (not shown) may be included at least between the preheating chamber 610 and the quenching chamber 630. The system 600 of FIG. 11 combines IR preheating and microwave heating in the same chamber, but may first preheat the glass sheet, and then, in the preheating chamber 610, use the gyrotron beam 626 to heat the glass sheet 650 to a tempering temperature profile prior to transfer of the sheet 650 to the quenching chamber 630 for quenching. Alternatively, the system 600 of FIG. 11 concurrently pre-heats and microwave-heats the glass 650. As can be appreciated from FIG. 11, the sequence of IR and microwave heating can be scheduled in a most optimized sequence so that the glass sheet is heated in an optimal manner, and as with any of the systems described herein, the timing and intensity of the preheating and timing and intensity of the microwave heating may be optimized to, e.g., save time, save energy, and/or to result in the best quality product. In one aspect, in order to achieve optimal heating on the glass sheet, the microwave energy may be collimated into a beam with the diameter between 10 mm to 150 mm. This focused beam may be used as a scanning beam across the surface of the glass with a defined power profile to achieve optimal glass heating in three dimensions.

A system 700 is provided as depicted schematically in FIG. 12. The system 700 includes an infrared preheating chamber 710, a microwave chamber 720, with a gyrotron 725 and a gyrotron beam 726, a quenching chamber 730, essentially as shown in FIG. 7, and a conveyor 740 with glass sheets 750. One or more doors (not shown) may be included at least between microwave chamber 720 and quenching chamber 730. The glass material may be first heated in the preheating chamber 710 by traditional IR heating or gas hearth (by convective heated gas flow) heating. The glass material may be first heated in the preheating chamber 710 by traditional IR heating or gas hearth (by convective heated gas flow) heating. The microwave chamber 720 includes an ultra high frequency microwave generator 725, such as a gyrotron, which produces a beam 726 that is used to heat the glass 750 to a tempering temperature profile. The microwave device (gyrotron 725) may be installed on the top of the microwave chamber 720, directing beam 726 downward, but, as with any aspect described herein, may also be installed at the bottom, with the beam 726 directed upward, or at any effective point in relation to the chamber 720. The microwave chamber 720 is short in length, e.g., shorter in length than the glass sheet 750, such that the glass sheet 750 may pass from the preheating chamber 710 to the quenching chamber 730 without a separate stop in the microwave chamber 720. The glass 750, once heated to a desired tempering temperature profile, may be transferred to a quenching chamber 730, where the glass is quenched by a controllable cooling system, which may comprise a nozzle system and compressed cooling air system, essentially as shown in FIG. 7. The three-stage system provides a simple production flow which can be easily adopted into any production system. In order to achieve optimal heating of the glass sheet, the microwave energy may be collimated into a beam with the diameter between 10 mm to 150 mm. This focused beam may be used as a scanning beam across the surface of the glass with a defined power profile to achieve the glass heating optimal desired heating in three dimensions.

A glass tempering method and system useful in minimizing glass defects due to excessive glass surface temperature and reflectance of a low emissivity coating is also provided. The method and system combines the traditional IR heating technology with microwave energy in a glass tempering process that can significantly reduce the glass tempering process cycle time, particularly for the low emissivity coated glass, and/or produce various glass tempers which is impossible to produce in the traditional glass tempering process. The method and system may significantly reduce the glass tempering cost by reducing the cycle time and/or minimizing product defects. The method and system provide flexible glass tempering capabilities for different glass temper products. As would be appreciated by those of ordinary skill, the glass product may have sides with different optical properties, one side typically being more reflective than the other. As a consequence, the microwave beam may be best applied from a side of the glass sheet with lower reflectivity. In a typical process, an upward-facing surface of the glass sheet is treated in a manner to have superior reflectivity as compared to a downward-facing surface. As such, the microwave beam may be applied to the least-reflective side of the glass sheet, which often is the bottom side of the sheet.

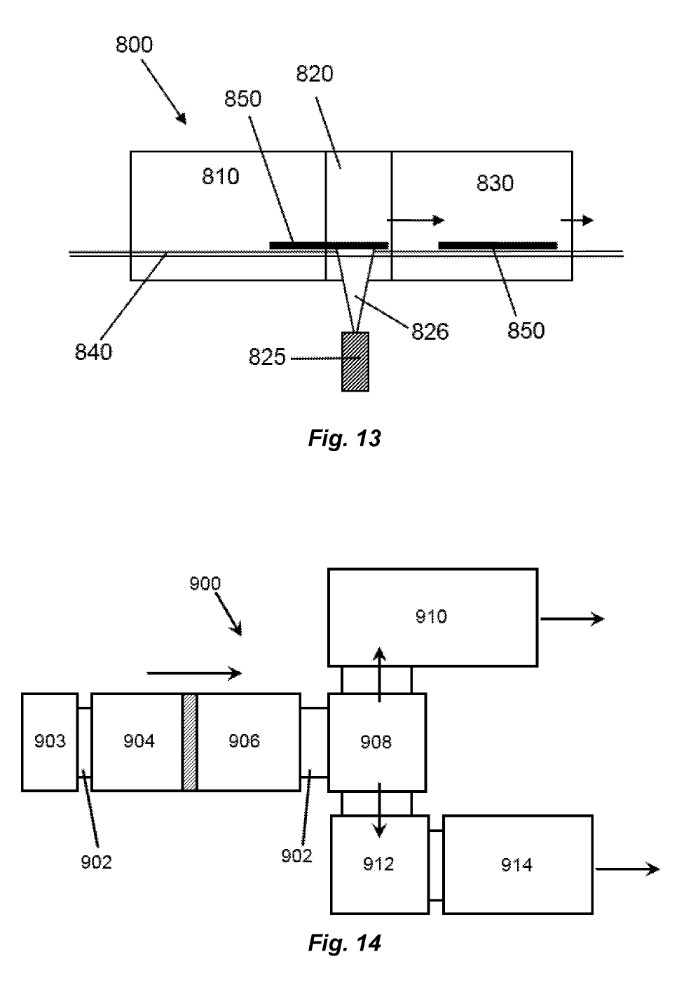

A system 800 is provided as depicted schematically in FIG. 13. The system 800 includes an infrared preheating chamber 810, a microwave chamber 820, with a gyrotron 825 and a gyrotron beam 826, a quenching chamber 830, essentially as shown in FIG. 7, and a conveyor 840 with glass sheets 850. One or more doors (not shown) may be included at least between microwave chamber 820 and quenching chamber 830. The glass material may be first heated in the preheating chamber 810 by traditional IR heating or gas hearth (by convective heated gas flow) heating. The depicted microwave chamber 820 includes an ultra high frequency microwave generator 825, such as gyrotron, which produces a beam 826 that is used to heat the glass 850 to a tempering temperature profile. The microwave device (gyrotron 825) is shown as being installed on the bottom of the microwave chamber 820, directing beam 826 upward, for directional heating of a glass sheet from the bottom. The microwave chamber 820 is short in length, e.g., shorter in length than the glass sheet 850, such that the glass sheet 850 passes from the preheating chamber 810 to the quenching chamber 830 without a separate stop in the microwave chamber 820. The glass 850, once heated to a desired tempering temperature profile, may be transferred to the quenching chamber 830, where the glass may be quenched by a controllable cooling system, which may comprise a nozzle system and compressed cooling air system, essentially as shown in FIG. 7. The three-stage system provides a simple production flow which can be easily adopted into any production system. In order to achieve optimal desired heating of the glass sheet, the microwave energy may be collimated into a beam with the diameter between 10 mm to 150 mm. This focused beam may be used as a scanning beam across the surface of the glass with a defined power profile to achieve uniformly heated glass in three dimensions. The systems depicted in FIGS. 10 and 11 likewise can be configured with the gyrotron beam 526 and 626 projecting upward to heat from the bottom.

Of note, with FIGS. 10, 11, 12, and 13, the microwave (gyrotron) beam is depicted as a single beam, but can be a single steady beam, a pulsed beam, a quasi-pulsed beam, or a beam having a size smaller than as depicted, that is moved over the surface of the glass sheet as described above. Further the beam can be split, for example as illustrated in FIGS. 4B and 4C to direct multiple beams onto the glass sheet. The beam may be split into 2, 3, 4, 5, 6, 7, 8, 9, or 10 individual, and optionally independently-controllable beams of the same or different intensity, size, etc., which may be controllable by motion of the optics and/or through use of appropriate optical or optical electronic filters or filtering mechanisms. Further, as applicable, the glass sheet 550, 650, 750, and 850 may pass through the preheating chamber 510, 610, 710, or 810 and microwave chamber 520, 720, or 820, to the quenching chamber 530, 630, 730, or 830, continuously or stopping at any point, or in each chamber, or variations thereof, such as moving continuously through the preheating chamber 510 and stopping at the microwave chamber 520 in FIG. 10, or oscillating in a forward and reverse direction to achieve uniform heating, or a desired heating profile. Although depicted as linear, movement of the glass sheets, and arrangement of the various components of the described systems can be in any effective direction, orientation, or configuration in space.

In any of the preceding examples, traditional IR heating energy may be used to pre-heat the glass to within the range of 900° F. to 1150° F., and microwave electromagnetic energy may be used to provide additional heating, to bring the glass to a tempering temperature, e.g., of 1182° F., or higher, depending on the composition, shape, and structure of the glass sheet and desired tempering profile. For example and without limitation, in the IR heating chamber, the glass sheet is preheated with high intensity IR (3.6 W/cm²), e.g., in an IR furnace set to 690° C. (1274° F.), until the glass average temperature reaches 605° C. (1121° F.) (surface about 625° C. (1127° F.), mid-plane about 595° C. (1103° F.).

In the systems and methods provided herein, the microwave energy can be a continuous, focused microwave beam with a diameter of between 10 mm to 150 mm, which continuously heats the glass sheet, or a pulsed, focused microwave beam with similar diameters but with a pulse width of 1 seconds to 25 seconds and a cycle time of between 1 minutes to 10 minutes.

Referring to FIGS. 12 and 13, the glass sheet may be heated to a desired pre-heating temperature target (1100° F. or lower), and then is transferred to the microwave chamber at a speed ranging from, for example, about 40 m/s to 20 m/s. In the microwave chamber 720 or 820, the microwave energy may be applied to the glass sheet either as a continuous wave formed as a focused beam, or as a pulsed wave formed as the focused beam. As the glass sheet passes through the microwave chamber 720 or 820, the glass sheet temperature may be attenuated due to the heat lost due to the surrounding environment, resulting in the leading edge of the glass sheet being cooler than the trailing edge when the sheet is transferred to the quenching chamber. To compensate for this event, a variable power curve may be applied to ensure the glass temperature uniformity once the glass sheet completely enters the quenching chamber. To compensate, the microwave beam may be attenuated from the leading edge to the trailing edge of the glass sheet, for example the microwave power gradually changes from 100% at the beginning of transfer of the sheet from the additive microwave energy chamber to 76%, e.g. from 40% to 99%, or from 70% to 85%, or any increment therebetween, or any tunable percentage of the power at the end of transfer (see, e.g. FIG. 2). The decrease in power from the leading edge to the trailing edge may be linear, or any effective shape. The overall power change and shape of the curve depicting the power change may be readily determined for any glass sheet, system, and/or processing procedure. The quenching action of the quenching station may begin when the glass is transferred into the quenching zone of the station. The quenching may be a continuous process that is conducted as the glass sheet moves into and through the quenching zone.

A semi-continuous glass manufacturing process also is provided, combining microwave glass bending with glass thermal tempering and chemical tempering processes to create to significantly improved glass quality and processing efficiency. The system and method combines microwave-based shaping, microwave based thermal tempering and microwave-based chemical tempering into a highly efficient and automatic glass making process from bending to tempering. This is expected to transform the current process flow from a manual and slow process into an automatic, and fast glass tempering process, thereby reducing labor and material costs. The components of a continuous glass bending-tempering system are shown in FIG. 14. System 900 includes the following connected by conveyor(s) 902:

Glass loading station 903: A mechanical system is used to load the raw glass;

Preheating chamber 904: An oven with top, bottom, front/back, and left/right wall IR heating elements. A conveyer drive system and a position measurement system may be used to ensure accurate carriage/tooling/glass positioning for high process repeatability. An optical measurement system also may be installed to provide the operator full-surface glass temperature information.

Microwave glass bending chamber 906: In this chamber, the main equipment is the microwave energy source as described herein (e.g., between 10 GHz to 100 GHz, and 1 KW to 60 KW). A gyrotron device may be used for the glass bending. The installed microwave energy source may be supplemented with a mirror system including an optical box and a mirror box, for example as described above. The optical box shapes the electrical magnetic wave generated from the microwave generator into a desired shape either a circle (10 mm to 200 mm in diameter), a stripe, or other shapes. The mirror box with 2·axis controlled motion projects the energy and scan on the surface of the glass sheet. Additionally, a supplemental IR heating system (e.g., top, bottom, left, right, back, and/or front wall) may be also included in this chamber to maintain proper ambient temperature for minimum glass heat lost during processing. Alternately, the microwave beam is split as described herein using a beam splitter.

Holding (temperature control) chamber 908: This chamber may be used to separate the glass stack into singlets (where required) and/or to heat the glass to a pre-tempering temperature. A robotic system can be used to achieve the mechanical separation of a glass stack. A three dimensional IR heating system may be installed to provide enough power to obtain desired glass pre-tempering temperature. As described herein, high power heating, e.g., microwave heating as described herein is used to heat glass to 1,200° F. before quenching. However, if the glass is to be chemically tempered, then the glass may proceed to a cooling (annealing) chamber. A glass temperature measurement system, such as non-contact IR temperature sensors, may be installed in this chamber to monitor glass temperature. Chamber 908 may comprise a gyrotron beam source as shown for example in FIG. 11, or a separate microwave chamber may be further included, as shown in FIG. 10, 12, or 13 between the chamber 908 and chamber 910, described below.

Thermal tempering (quenching) chamber 910: In this chamber, the glass is cooled with a designed rate to achieve proper temper level, for example as shown in FIG. 7.

Glass annealing (cooling) chamber 912: if the glass product is a chemical tempering product, then the glass is transported from the holding chamber 908 into this chamber for annealing. In order to achieve controllable annealing schedule, the controllable cooling equipment, such as the IR heating coils and controllable cooling fan system, is installed in this chamber.

Microwave chemical tempering chamber 914: A new approach to chemically tempering glass is used in this chamber (See, e.g. FIG. 9). The process benefits of the microwave based chemical tempering are speed and efficiency of the ion exchange process occurring in a microwave-based tempering chamber.

The following clauses describe various aspects of the invention:
1. A method of strengthening a glass sheet, comprising:
   a. heating the glass sheet to a tempering temperature using a microwave beam produced by a microwave generator; and
   b. quenching the glass sheet heated to the tempering temperature using the microwave beam to produce a tempered glass sheet.
2. The method of clause 1, further comprising, prior to or concurrently with heating the glass sheet to a tempering temperature using the microwave beam, heating the glass sheet in an oven with an ambient temperature below a tempering temperature of the glass sheet.
3. The method of clause 2, wherein the ambient temperature of the oven ranges from 1100° F. to 1200° F.
4. The method of any one of clauses 1-3, wherein the microwave generator is an ultra high frequency microwave generator.
5. The method of clause 1, wherein the ultra high frequency microwave generator is an ultra high frequency microwave generator having an output ranging from 30 GHz to 300 GHz and a power output of from 1 kW to 100 kW.
6. The method of clause 5, wherein the microwave beam is pulsed, with a pulse output greater than 1 kW.
7. The method of clause 1, wherein the ultra high frequency microwave generator is a gyrotron.
8. The method of any of clauses 1-7, wherein the glass sheet is a flat sheet.
9. The method of clause 1, wherein the glass sheet is non-planar.
10. The method of clause 9, further comprising, prior to heating the glass sheet to the tempering temperature of the glass sheet, shaping the non-planar glass sheet at a temperature over a sag temperature of the glass sheet, and cooling the glass sheet to a temperature below the sag temperature of the glass sheet.
11. The method of clause 10, wherein the shaping is performed in a first oven, and the heating to a tempering temperature is performed in a second oven.
12. The method of any of clauses 1-11, wherein the glass sheet is a multi-layer laminate having a reflective side and the microwave beam produced by the ultra high frequency microwave generator heats the glass sheet from a side opposite the reflective side.
13. The method of any of clauses 1-12, wherein the microwave beam produced by an ultra high frequency microwave generator is split into a plurality of microwave beams.
14. The method of clause 13, wherein the glass sheet is carried into the oven by a conveyor having a plurality of openings and the plurality of microwave beams pass through the plurality of openings in the conveyor.
15. The method of any of clauses 1-14, wherein the glass sheet is oscillated while the glass sheet is heated to a tempering temperature.
16. The method of any of clauses 1-15, wherein the glass sheet is transferred from the oven to a quenching chamber for the quenching.
17. The method of any one of clauses 1-16, wherein the glass sheet has a leading edge and a trailing edge, and wherein the leading edge is heated to a tempering temperature higher than that of the trailing edge prior to quenching.
18. The method of clause 17, wherein the temperature profile of the glass sheet in the quenching chamber prior to quenching from the leading edge to the trailing edge is isothermal.
19. The method of any one of clauses 1-18, wherein the microwave beam produced by an ultra high frequency microwave generator heats an internal point in the glass sheet to a temperature equal to or higher than a temperature on a point on a surface of the glass sheet overlying the internal point.
20. The method of any one of clauses 1-18, wherein the glass sheet is pre-heated, transferred to a second position where it is heated to the tempering temperature using the microwave beam produced by an ultra high frequency microwave generator, and transferred to a quenching chamber.
21. The method of any one of clause 1-20, further comprising:
   a. monitoring the surface temperature of at least a portion of the glass sheet during heating of the glass sheet with the microwave beam;
   b. comparing the monitored surface temperature with a stored temperature profile in a computer system to identify one or more points on the glass sheet that need to be heated to match the stored temperature profile and to determine an amount of heating at each of the one or more points needed to match the stored temperature profile; and
   c. heating the one or more points on the glass sheet to match the stored temperature by directing the microwave beam to the one or more points for a sufficient time to heat those points to match the stored temperature profile.
22. A system for production of a tempered glass product, comprising:
   a. a glass tempering quenching chamber comprising a forced-air manifold and at least one opening;
   b. a conveyor system for conveying a glass sheet extending into the quenching chamber; and
   c. a microwave generator that produces a microwave beam that intersects a position of a glass sheet carried on the conveyor system adjacent to the quenching chamber such that a glass sheet carried by the conveyor is transferred directly from the position on the conveyor system that intersects the microwave beam into the quenching chamber.
23. The system of clause 22, wherein the microwave generator is an ultra high frequency microwave generator.
24. The system of clauses 22 or 23, comprising:
   a. a first oven comprising an infrared (IR) or gas heating element and at least one opening;
   b. a glass tempering quenching chamber comprising a forced-air manifold and at least one opening;
   c. a conveyor system for conveying a glass sheet extending into the first oven, from the first oven to the quenching chamber, and exiting the quenching chamber; and
   d. a microwave generator that produces a microwave beam that intersects a position of a glass sheet carried on the conveyor either in the first oven or between the first oven and the quenching chamber.
25. The system of clause 24, wherein the conveyor is configured to:
   a. carry a glass sheet into the first oven through a first opening of the at least one opening of the first oven;
   b. transfer the glass sheet to the quenching chamber through either the first opening of the first oven or a second opening of the at least one opening of the first oven, and through a first opening of the at least one opening of the quenching chamber; and
   c. carry the glass sheet out of the quenching chamber through either the first opening of the quenching chamber or a second opening of the at least one opening of the quenching chamber.
26. The system of clause 24, further comprising a microwave chamber having at least one opening into which the conveyor extends into the microwave chamber through a first opening of the at least one opening of the microwave chamber, and is configured to transfer a glass sheet from the first oven and from the microwave chamber to the quenching chamber, and wherein the ultra high frequency microwave generator produces a microwave beam that intersects a position of a glass sheet carried on the conveyor in the microwave chamber.
27. The system of clause 24, wherein the first oven has a second opening, the quenching chamber has a second opening, the microwave chamber has a first opening and a second opening, and the conveyor passes in sequence, through the first and second openings of the first oven, through the first and second openings of the microwave chamber and through the first and second openings of the quenching chamber.
28. The system of clause 24, wherein the microwave generator produces a microwave beam that intersects a position of a glass sheet carried on the conveyor in the first oven.
29. The system of clause 24, wherein the first oven has a second opening, the quenching chamber has a second opening, and the conveyor passes through the first and second openings of the first oven and the first and second openings of the quenching chamber.
30. The system of clause 23, wherein the ultra high frequency microwave generator is a gyrotron.
31. The system of any one of clauses 22-30, wherein the microwave generator further comprises a beam splitter, dividing the microwave beam produced by the microwave generator into two or more microwave beams, and each of the two or more microwave beams intersects a position of a glass sheet carried on the conveyor.
32. The system of any one of clauses 22-31, wherein the beam or beams from the microwave generator are directed from below the conveyor through one or more openings in the conveyor.
33. The system of any one of clauses 22-21, wherein the beam or beams from the microwave generator are directed from above the glass sheet.
34. The system of any one of clauses 22-33, wherein one or more of the openings comprises a door.
35. A method of strengthening a glass sheet, comprising:
   a. contacting the glass sheet with ions with a larger ionic radius than ions in the glass sheet; and
   b. heating the glass sheet using a microwave beam produced by an ultra high frequency microwave generator.
36. A glass sheet produced according to the method of clause 1.

Having described this invention, it will be understood to those of ordinary skill in the art that the same can be performed within a wide and equivalent range of conditions, formulations and other parameters without affecting the scope of the invention or any embodiment thereof.

We claim:

1. A method of strengthening a glass sheet, comprising:
a. heating the glass sheet to a tempering temperature using a microwave beam produced by a microwave generator; and
b. quenching the glass sheet heated to the tempering temperature using the microwave beam to produce a tempered glass sheet.

2. The method of claim 1, further comprising, prior to or concurrently with heating the glass sheet to a tempering temperature using the microwave beam, heating the glass sheet in an oven with an ambient temperature below a tempering temperature of the glass sheet.

3. The method of claim 2, wherein the ambient temperature of the oven ranges from 1100° F. to 1200° F.

4. The method of claim 1, wherein the microwave generator is an ultra high frequency microwave generator.

5. The method of claim 4, wherein the ultra high frequency microwave generator has an output ranging from 30 GHz to 300 GHz and a power output of from 1 kW to 100 kW.

6. The method of claim 1, wherein the microwave generator comprises a gyrotron.

7. The method of claim 1, wherein the glass sheet comprises a multi-layer laminate having a reflective side and the microwave beam produced by the ultra high frequency microwave generator heats the glass sheet from a side opposite the reflective side.

8. The method of claim 1, wherein the microwave beam produced by the microwave generator is split into a plurality of microwave beams.

9. The method of claim 1, wherein the glass sheet has a leading edge and a trailing edge, and wherein the leading edge is heated to a tempering temperature higher than that of the trailing edge prior to or during transfer of the glass sheet to the quenching chamber.

10. The method of claim 1, wherein the glass sheet is pre-heated, transferred to a second position where it is heated to the tempering temperature using the microwave beam produced by the microwave generator, and transferred to a quenching chamber.

11. The method of claim 1, further comprising:
a. monitoring the surface temperature of at least a portion of the glass sheet during heating of the glass sheet with the microwave beam;
b. comparing the monitored surface temperature with a stored temperature profile in a computer system to identify one or more points on the glass sheet that need to be heated to match the stored temperature profile and to determine an amount of heating at each of the one or more points needed to match the stored temperature profile; and
c. heating the one or more points on the glass sheet to match the stored temperature by directing the microwave beam to the one or more points for a sufficient time to heat those points to match the stored temperature profile.

12. A glass sheet produced according to the method of claim 1.

13. A method of strengthening a glass sheet, comprising:
a. contacting the glass sheet with ions with a larger ionic radius than ions in the glass sheet; and
b. heating the glass sheet using a microwave beam produced by an ultra high frequency microwave generator.

14. A glass sheet produced according to the method of claim 13.

15. A system for production of a tempered glass product, comprising:
a. a glass tempering quenching chamber comprising a forced-air manifold and at least one opening;
b. a conveyor system for conveying a glass sheet extending into the quenching chamber; and
c. a microwave generator that produces a microwave beam that intersects a position of a glass sheet carried on the conveyor system adjacent to the quenching chamber such that a glass sheet carried by the conveyor is transferred directly from the position on the conveyor system that intersects the microwave beam into the quenching chamber.

16. The system of claim 15, wherein the microwave generator is an ultra high frequency microwave generator.

17. The system of claim 15, comprising:
a. a first oven comprising an infrared (IR) or gas heating element and at least one opening;
b. a glass tempering quenching chamber comprising a forced-air manifold and at least one opening;
c. a conveyor system for conveying a glass sheet extending into the first oven, from the first oven to the quenching chamber, and exiting the quenching chamber; and
d. a microwave generator that produces a microwave beam that intersects a position of a glass sheet carried on the conveyor either in the first oven or between the first oven and the quenching chamber.

18. The system of claim 15, further comprising a microwave chamber having at least one opening into which the conveyor extends into the microwave chamber through a first opening of the at least one opening of the microwave chamber, and is configured to transfer a glass sheet from the first oven and from the microwave chamber to the quenching chamber, and wherein the microwave generator produces a microwave beam that intersects a position of a glass sheet carried on the conveyor in the microwave chamber.

19. The system of claim 15, wherein microwave generator is a gyrotron.

20. The system of claim 15, wherein the microwave generator further comprises a beam splitter, dividing the microwave beam produced by the microwave generator into two or more microwave beams, and each of the two or more microwave beams intersects a position of a glass sheet carried on the conveyor.
